(19) United States
(12) Patent Application Publication
(10) Pub. No.: US 2012/0264395 A1
(43) Pub. Date: Oct. 18, 2012

(54) METHODS AND SYSTEMS FOR ROUTING CALLS AT A CALL CENTER BASED ON SPOKEN LANGUAGES

(75) Inventors: Travis L. Bradburn, Ortonville, MI (US); Eric J. Walper, Warren, MI (US); Chester A. Huber, Grosse Pointe Farms, MI (US); Scott A. Kubicki, Sammamish, WA (US); David Rymas, Troy, MI (US); Jason J. Parks, White Lake, MI (US)

(73) Assignee: GENERAL MOTORS LLC, DETROIT, MI (US)

(21) Appl. No.: 13/509,183

(22) PCT Filed: Nov. 12, 2009
(86) PCT No.: PCT/US09/64152

§ 371 Date: Jul. 3, 2012

(51) Int. Cl. H04W 4/22; H04M 3/00

(52) U.S. Cl. 455/404.1; 379/265.12

(57) ABSTRACT

Various examples of a methods and systems are disclosed herein for routing calls at a call center based on spoken languages. In one example, a method includes, but is not limited to, receiving, by a call center, information indicating a request for assistance from a driver of a vehicle and information indicating one or more languages spoken by the driver. The call center automatically identifies an available advisor who speaks at least one language spoken by the driver. The call center automatically directs the request for assistance to the available advisor.

### CROSS-REFERENCE TO RELATED APPLICATIONS

This application is a U.S. National-Stage entry under 35 U.S.C. § 371 based on International Application No. PCT/US2009/064152, filed Nov. 12, 2009, which was published under PCT Article 21(2), and is hereby incorporated in its entirety by reference.

### TECHNICAL FIELD

The technical field generally relates to methods and systems for routing calls at a call center, and more particularly relates to methods and systems for routing calls based on the spoken language of multiple parties.

### BACKGROUND

Some vehicles in the market-place include communication equipment that enables a driver to communicate with, and to receive assistance from, a remotely located call center. The call center is manned with trained advisors who stand ready to provide a wide variety of services including, but not limited to, crash response assistance, turn-by-turn navigation guidance, and vehicle diagnostics.

Communication between the advisor and the driver is verbal, and effective communication is made more difficult when the advisor and the driver do not speak a common language. Using current systems, a driver's call is routed to an available advisor, who may or may not speak a common language with the driver. When the advisor does not speak a common language, he or she must attempt to find another available advisor who does. This may result in significant delays in providing the driver with service.

In some geographical locations, more than one language is commonly used. For instance, in parts of Canada, both English and French are commonly spoken and the call center may routinely field calls from both English and French speaking subscribers. One solution employed to accommodate this situation is to record, in a subscriber's profile, an identification of the language that the subscriber speaks. The subscriber's profile is maintained at the call center. When an incoming call is received by the call center from the subscriber, the subscriber's profile is consulted to determine the language spoken by the subscriber and the incoming call is routed to an advisor who speaks that language.

When a driver contacts an advisor to request emergency services, standard procedures may include the advisor establishing contact with a public service answering point (hereinafter “PSAP”) having jurisdiction over the driver, such as fire, police and/or medical emergency dispatchers. However, in some cases, the advisor may not speak a common language with the PSAP staff, and delays in emergency service provision may occur.

It may be routine in the United States for drivers, advisors, and PSAPs to all speak/support a common language. However, in other countries, some or all of the parties may frequently speak different languages. For example, in European countries, drivers routinely drive to and through foreign countries where different languages are spoken.

Accordingly, methods are desired for providing more effective communication between a driver and an advisor and/or between an advisor and a PSAP in situations in which the driver, advisor, and/or PSAP staff do not speak a common language. Furthermore, other desirable features and characteristics will become apparent from the subsequent detailed description and the appended claims, taken in conjunction with the accompanying drawings and the foregoing technical field and background.

### SUMMARY

Various examples of methods and systems for routing calls at a call center based on spoken languages are disclosed herein. In one non-limiting example, the method includes, but is not limited to receiving, by a call center, an electronic signal containing a request for assistance from a driver of a vehicle. The electronic signal also contains an identification of one or more languages spoken by the driver. The method further includes automatically identifying, by the call center, an available advisor who speaks at least one of the one or more languages spoken by the driver. The method also includes directing the request for assistance to the available advisor.

In a second, non-limiting example, a method for routing calls at a call center based on spoken languages includes, but is not limited to, receiving, by a call center, information indicating a request for assistance from a driver of a vehicle and information indicating one or more languages spoken by the driver. The method further includes automatically identifying, by the call center, a PSAP with responsibility for providing emergency services to the driver. The method further includes automatically determining, by the call center, one or more languages spoken at the PSAP. The method also includes automatically identifying, by the call center, an available advisor who speaks at least one of the one or more languages spoken by the driver and at least one of the one or more languages spoken at the PSAP. The method still further includes automatically directing the request to the available advisor.

In a third non-limiting example, a system for routing calls based on spoken languages includes, but is not limited to, a call center that houses communication equipment and computer equipment communicatively connected to one another. Multiple advisors are located within the call center. The communication equipment is configured to receive a wireless electronic signal from a vehicle. The wireless electronic signal contains information identifying a language spoken by a driver of the vehicle. The communication equipment is also configured to automatically communicate the wireless electronic signal to the computer equipment. The computer equipment is configured to automatically determine from the wireless electronic signal the language spoken by the driver of the vehicle, to automatically identify an advisor of the plurality of advisors who speaks the language spoken by the driver of the vehicle, and to automatically route the request for assistance to that advisor.

### DESCRIPTION OF THE DRAWINGS

One or more examples will hereinafter be described in conjunction with the following drawing figures, wherein like numerals denote like elements, and

FIG. 1 is a schematic view illustrating a non-limiting example of a communication system suitable for use with examples of the method disclosed herein for routing calls from a driver of a remotely located vehicle to an advisor at a call center;

FIGS. 2-4 are schematic views illustrating non-limiting examples of a system for routing calls from the driver of a remotely located vehicle to an advisor at a call center based on languages spoken by the driver and by the advisor; and

FIGS. 5-7 are schematic views illustrating non-limiting examples of a system for routing calls from the driver of a remotely located vehicle to an advisor at a call center based on languages spoken by the driver, by the advisor and by a PSAP.

FIG. 8 is a flow chart illustrating a non-limiting example of the methods disclosed herein for routing calls from the driver of a remotely located vehicle to an advisor at a call center based on languages spoken by various parties.

### DETAILED DESCRIPTION

The following detailed description is merely exemplary in nature and is not intended to limit application and uses. Furthermore, there is no intention to be bound by any expressed or implied theory presented in the preceding technical field, background, brief summary or the following detailed description.

As discussed above, some vehicles available for sale in the marketplace are equipped with communications equipment and computer equipment running a variety of software programs (hereinafter “vehicle hardware”) that enable a driver to communicate with a call center that offers a variety of services to the driver. To provide these services, the call center is equipped with communications equipment and computer equipment and is also staffed with human advisors (hereinafter “advisors”) who are trained to provide drivers with a variety of types of assistance. Typically the advisors are positioned at work stations within the call center. The work stations are electronically arranged in a queue and incoming calls for assistance are routed to the next available advisor in the queue. The protocol for populating the queue may be any conventional protocol, for example, a first in-first out protocol. The work station may be added to the queue when the advisor stationed at the work station comes on duty and may be removed from the queue when the advisor is communicating with a driver and then returned to the queue upon the completion of such communication.

According to an example, the vehicle hardware is configured to run voice recognition programs that enable the driver to verbally engage with the vehicle hardware at times when the driver requests assistance. The vehicle hardware is configured to operate in multiple languages. According to an example, during the process of registering for service, the driver is asked to designate a language spoken by the driver that will be the primary language spoken by the driver when interacting verbally with the vehicle hardware. The primary language designated by the driver is recorded in the vehicle hardware (e.g., stored in a memory device) and, once designated, the vehicle hardware may verbally engage with the driver in that language. In some examples, the communications equipment may permit the driver to select a secondary language. In still other examples, a tertiary language or more than three languages may also be designated.

Whenever the driver initiates contact with the call center, the vehicle hardware wirelessly transmits an electronic signal that conveys several items of information to the call center. The electronic signal includes a vehicle identification number (hereinafter “VIN”) that is unique to the vehicle that the driver is driving. The electronic signal further includes a station identifier (hereinafter “STID”) that is unique to the vehicle hardware that the driver is using to communicate with the call center. The electronic signal also includes the location of the vehicle in the form of latitude and longitude coordinates. According to an example, the electronic signal further includes an identification of the primary language spoken by the driver, and, if designated, identifications of a secondary and tertiary language spoken by the driver, and so on.

According to one example of the method disclosed herein, communication and computer equipment at the call center (hereinafter “call center equipment”) receives the electronic signal from the vehicle and parses the signal electronically to determine the primary language spoken by the driver (as well as the secondary and/or any other language identified by the driver, if designated). The call center may be staffed with advisors who speak a variety of different languages. In some examples, some or all of the advisors may speak multiple languages. The language(s) spoken by each advisor is stored on an electronic data storage component (e.g., a database on a hard drive) that is accessible to the call center equipment. After the call center equipment has identified the language spoken by the driver, the call center equipment accesses the electronic data storage component to identify the available advisors in the queue who are able to speak the primary language spoken by the driver. The call center equipment then routes the driver's call for assistance to the advisor at or nearest the front of the queue who speaks the primary language spoken by the driver.

The communication equipment in the vehicle may have multiple buttons, control features, or other types of actuators, each being associated with a different type of service provided by the call center. By depressing a specific button, the driver can electronically indicate to the call center the type of assistance he requires. Some types of assistance will necessarily require that the advisor involve a PSAP or other external entity (e.g., providers of emergency services such as dispatchers of law enforcement officers, fire fighters, and/or emergency medical technicians).

PSAPs typically have responsibility for defined geographic regions. The PSAP with jurisdiction over the driver who has requested assistance may be staffed with employees who speak one or more languages that is/are different from that of the primary language spoken by the driver. Accordingly, it may be desirable for the call center equipment to route the incoming call for assistance to an advisor who, in addition to speaking the primary language spoken by the driver, also speaks the language spoken by personnel staffing the PSAP. To accommodate this, in an example, the call center equipment maintains files in a database that identify the PSAPs having jurisdiction over each geographic region that falls within an area where the call center provides service. The language or languages spoken at each PSAP is also recorded in the database.

Another example of the method disclosed herein includes the call center equipment receiving the electronic signal from the vehicle and electronically parsing the signal to determine the primary language spoken by the driver. The call center also determines from location information (e.g., the latitude and longitude coordinates) included in the signal the approximate location of the vehicle. With this information, the call center equipment next determines which PSAP has responsibility for providing assistance to the vehicle and what language or languages is spoken at the PSAP. Next, the call center equipment identifies available advisors in the queue who are capable of speaking both the primary language spoken by the driver (or a secondary or tertiary language) and one or more of the language(s) spoken at the PSAP, according to an example. The call center equipment then routes the call for assistance to one of the identified available advisors who is at or nearest the front of the queue.

In instances where there are no advisors available who speak both a language spoken by the driver and a language spoken by the PSAP, the call center equipment may identify a first advisor who speaks both a language spoken by the driver and an additional language. The call center equipment may then identify a second advisor who speaks the language of the PSAP and the additional language spoken by the first advisor. The call center will then route the call for assistance to the first advisor who may communicate directly with the driver and who will coordinate with the second advisor, where the second advisor may contact and speak directly with the responsible PSAP, according to an example.

A greater understanding of the examples of the methods and systems disclosed herein may be obtained through a review of the illustrations accompanying this application together with a review of the detailed description that follows.

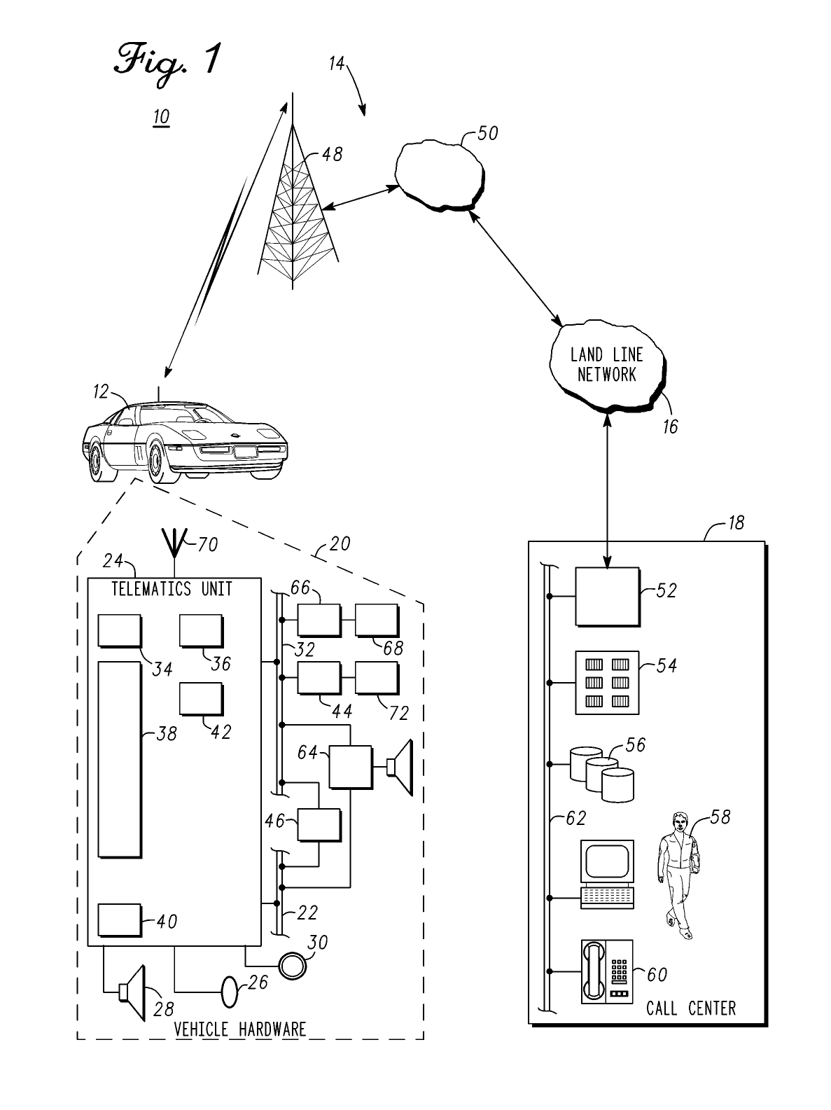

With reference to FIG. 1, there is shown a non-limiting example of a communication system 10 that may be used to implement examples of the method disclosed herein. The communication system generally includes a vehicle 12, a wireless carrier system 14, a land network 16 and a call center 18. It should be appreciated that the overall architecture, setup and operation, as well as the individual components of the illustrated system are merely exemplary and that differently configured communication systems may also be utilized to implement the examples of the method disclosed herein. Thus, the following paragraphs, which provide a brief overview of the illustrated communication system 10, are not intended to be limiting.

Vehicle 12 may be any type of mobile vehicle such as a motorcycle, car, truck, recreational vehicle (RV), boat, plane, etc., and is equipped with suitable hardware and software that enables it to communicate over system 10. Some of the vehicle hardware 20 is shown generally in FIG. 1 including a telematics unit 24, a microphone 26, a speaker 28, and buttons and/or controls 30 connected to the telematics unit 24. Operatively coupled to the telematics unit 24 is a network connection or vehicle bus 32. Examples of suitable network connections include a controller area network (CAN), a media oriented system transfer (MOST), a local interconnection network (LIN), an Ethernet, and other appropriate connections such as those that conform with known ISO (International Organization for Standardization), SAE (Society of Automotive Engineers), and/or IEEE (Institute of Electrical and Electronics Engineers) standards and specifications, to name a few.

The telematics unit 24 is an onboard device that provides a variety of services through its communication with the call center 18, and generally includes an electronic processing device 38, one or more types of electronic memory 40, a cellular chipset/component 34, a wireless modem 36, a dual mode antenna 70, and a navigation unit containing a GPS chipset/component 42. In one example, the wireless modem 36 includes a computer program and/or set of software routines adapted to be executed within processing device 38.

The telematics unit 24 may provide various services including: turn-by-turn directions and other navigation-related services provided in conjunction with the GPS based chipset/component 42; airbag deployment notification and other emergency or roadside assistance-related services provided in connection with various crash and/or collision sensor interface modules 66 and collision sensors 68 located throughout the vehicle; and/or infotainment-related services where music, internet web pages, movies, television programs, videogames, and/or other content are downloaded by an infotainment center 46 operatively connected to the telematics unit 24 via vehicle bus 32 and audio bus 22. In one example, downloaded content is stored for current or later playback. The above-listed services are by no means an exhaustive list of all the capabilities of telematics unit 24, but are simply an illustration of some of the services that the telematics unit may be capable of offering. It is anticipated that telematics unit 24 may include a number of additional components in addition to and/or different components from those listed above.

Vehicle communications may use radio transmissions to establish a voice channel with wireless carrier system 14 so that both voice and data transmissions can be sent and received over the voice channel. Vehicle communications are enabled via the cellular chipset/component 34 for voice communications and the wireless modem 36 for data transmission. In order to enable successful data transmission over the voice channel, wireless modem 36 applies some type of encoding or modulation to convert the digital data so that it can be communicated through a vocoder or speech codec incorporated in the cellular chipset/component 34. Any suitable encoding or modulation technique that provides an acceptable data rate and bit error can be used with the present examples. Dual mode antenna 70 services the GPS chipset/component 42 and the cellular chipset/component 34.

Microphone 26 provides the driver or other vehicle occupant with a means for inputting verbal or other auditory commands, and can be equipped with an embedded voice processing unit utilizing a human/machine interface (HMI) technology known in the art. Conversely, speaker 28 provides audible output to the vehicle occupants and can be either a stand-alone speaker specifically dedicated for use with the telematics unit 24 or can be part of a vehicle audio component 64. In either event, microphone 26 and speaker 28 enable vehicle hardware 20 and call center 18 to communicate with the occupants through audible speech. The vehicle hardware also includes one or more buttons or controls 30 for enabling a vehicle occupant to activate or engage one or more of the vehicle hardware components 20. For example, one of the buttons 30 can be an electronic pushbutton used to initiate voice communication with call center 18 (whether it be a human such as advisor 58 or an automated call response system). In another example, one of the buttons 30 can be used to initiate emergency services.

The audio component 64 is operatively connected to the vehicle bus 32 and the audio bus 22. The audio component 64 receives analog information, rendering it as sound, via the audio bus 22. Digital information is received via the vehicle bus 32. The audio component 64 provides amplitude modulated (AM) and frequency modulated (FM) radio, compact disc (CD), digital video disc (DVD), and multimedia functionality independent of the infotainment center 46. Audio component 64 may contain a speaker system, or may utilize speaker 28 via arbitration on vehicle bus 32 and/or audio bus 22.

The vehicle crash and/or collision detection sensor interface 66 is operatively connected to the vehicle bus 32. The collision sensors 68 provide information to the telematics unit via the crash and/or collision detection sensor interface 66 regarding the severity of a vehicle collision, such as the angle of impact and the amount of force sustained.

Vehicle sensors 72, connected to various sensor interface modules 44 are operatively connected to the vehicle bus 32. Example vehicle sensors include but are not limited to gyroscopes, accelerometers, magnetometers, emission detection, and/or control sensors, and the like. Example sensor interface modules 44 include powertrain control, climate control, and body control, to name but a few.

Wireless carrier system 14 may be a cellular telephone system or any other suitable wireless system that transmits signals between the vehicle hardware 20 and land network 16. According to an example, wireless carrier system 14 includes one or more cell towers 48, base stations and/or mobile switching centers (MSCs) 50, as well as any other networking components required to connect the wireless system 14 with land network 16. As appreciated by those skilled in the art, various cell tower/base station/MSC arrangements are possible and could be used with wireless system 14. For example, a base station and a cell tower could be co-located at the same site or they could be remotely located, and a single base station could be coupled to various cell towers or various base stations could be coupled with a single MSC, to list but a few of the possible arrangements. A speech codec or vocoder may be incorporated in one or more of the base stations, but depending on the particular architecture of the wireless network, it could be incorporated within a Mobile Switching Center or some other network components as well.

Land network 16 can be a conventional land-based telecommunications network that is connected to one or more landline telephones, and that connects wireless carrier network 14 to call center 18. For example, land network 16 can include a public switched telephone network (PSTN) and/or an Internet protocol (IP) network, as is appreciated by those skilled in the art. Of course, one or more segments of the land network 16 can be implemented in the form of a standard wired network, a fiber or other optical network, a cable network, other wireless networks such as wireless local networks (WLANs) or networks providing broadband wireless access (BWA), or any combination thereof

Call center 18 is designed to provide the vehicle hardware 20 with a number of different system back-end functions and, according to the example shown here, generally includes one or more switches 52, servers 54, databases 56, advisors 58, as well as a variety of other telecommunication/computer equipment 60. These various call center components are suitably coupled to one another via a network connection or bus 62, such as the one previously described in connection with the vehicle hardware 20. Switch 52, which can be a private branch exchange (PBX) switch, routes incoming signals so that voice transmissions are usually sent to either the live advisor 58 or an automated response system, and data transmissions are passed on to a modem or other piece of equipment 60 for demodulation and further signal processing. The modem 60 may include an encoder, as previously explained, and can be connected to various devices such as a server 54 and database 56. For example, database 56 could be designed to store subscriber profile records, subscriber behavioral patterns, or any other pertinent subscriber information. Although the illustrated example has been described as it would be used in conjunction with a manned call center 18, it will be appreciated that the call center 18 can be any central or remote facility, manned or unmanned, mobile or fixed, to or from which it is desirable to exchange voice and data.

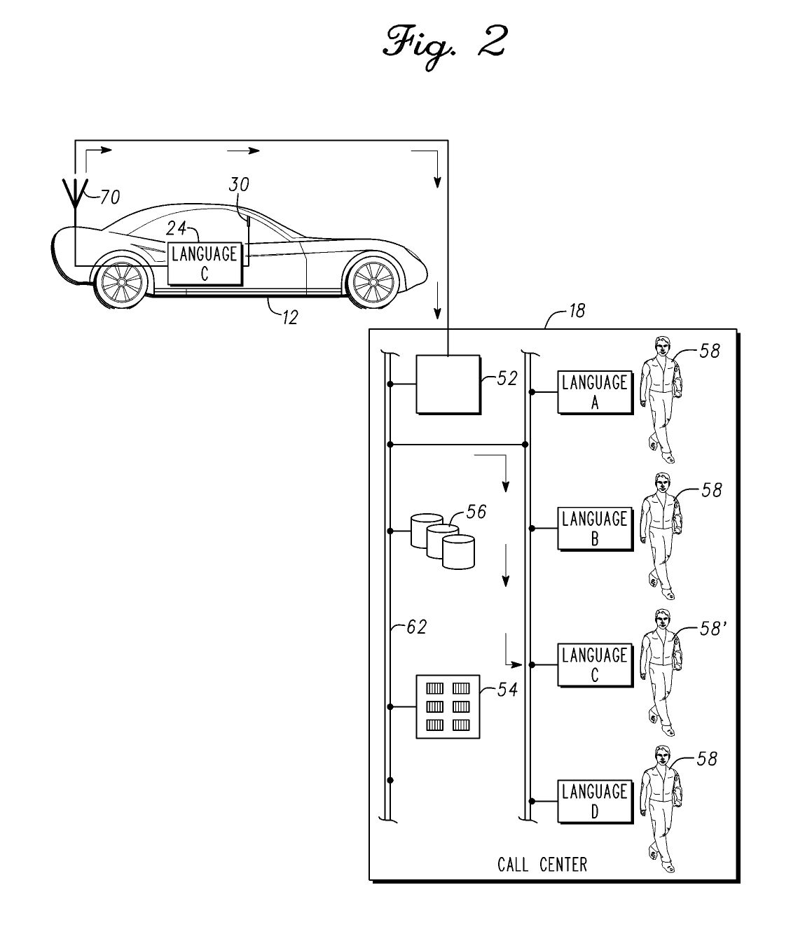

FIG. 2 schematically illustrates an example of a system in which a method for routing calls in accordance with the present disclosure may be implemented. In an example, when vehicle 12 is purchased from a vehicle dealership, the purchaser fills out a variety of types of paperwork and documentation associated with acquiring ownership of the vehicle. As part of the process of purchasing the vehicle and filling out the paperwork, the purchaser can elect to obtain a subscription account with call center 18. It is during the process of purchasing vehicle 12 and selecting services from call center 18 when the purchaser may identify a primary language, a secondary language, a tertiary language and/or any additional languages that the purchaser is capable of speaking. The purchaser's identification of spoken languages is provided to call center 18 shortly after the completion of the purchase process.

In another example, rather than filling out paperwork at a vehicle dealership, the purchaser/driver may simply activate one of the buttons and/or controls 30 in vehicle 12 to contact call center 18. Once communications with call center 18 has been established, the purchaser/driver may verbally set up an account and select desired services. During this process, the purchaser/driver may identify primary, secondary, tertiary, etc. . . languages.

In an example, once call center 18 receives information regarding the languages spoken by the purchaser, call center 18 accesses telematics unit 24 in vehicle 12 and configures telematics unit 24 to communicate with the purchaser/driver in the primary language. Call center 18 further configures telematics unit 24 to record the additional languages that the purchaser/driver is capable of speaking. In an example, the recording of languages spoken by the purchaser/driver may be recorded in electronic memory 40.

In an example, the languages spoken by each advisor 58 is recorded in database(s) 56. The each advisor 58 may inform administrative staff at call center 18 of the language or languages that the advisor 58 is capable of speaking at the time advisor 58 seeks employment with call center 18 or at the time that advisor 58 is accepts an offer of employment, or at any other suitable time. In other examples, advisor 58 may include an identification of the languages that the advisor is capable of speaking at the time that the advisor 58 logs in to a workstation at call center 58. Other methods which are effective to convey the languages spoken by advisor 58 to call center 18 may also be employed.

Referring to FIGS. 1 and 2, a driver 74 depresses one of the buttons and/or controls 30 associated with vehicle hardware 20 in an attempt to request assistance from call center 18. This action sends an electronic signal to telematics unit 24 prompting it to initiate contact with call center 18. In an example, in response to the button push, telematics unit 24 retrieves the primary language and any additional languages spoken by the purchaser/driver from electronic memory 40 and transmits a wireless electronic signal through dual mode antenna 70. The wireless electronic signal includes a carrier wave and information identifying the primary language (and additional languages) spoken by driver 74, according to an example. The wireless electronic signal may also include additional information such as the latitude and longitude coordinates of vehicle 12 and an identification of the type of assistance that the driver requires.

The wireless electronic signal may be directed through various communications networks, including wireless carrier system 14 and land network 16 (not shown in FIGS. 2) to call center 18. The wireless electronic signal enters call center 18 through switches 52. When the signal is received, the call center electronically determines, from the signal, the primary language spoken by the driver. This may be accomplished using computer equipment and software integrated into, or associated with, switches 52, or through cooperation between switch 52, servers 54, and databases 56, which may communicate with one another across bus 62.

Once the primary language spoken by the driver is determined, an advisor 58 capable of speaking the primary language spoken by the driver is identified. This may be accomplished through cooperation between servers 54 and databases 56. In the illustrated example, the driver designated language “C” as the driver's primary language. As used herein, the identification of a language with quotes surrounding a capital letter (e.g., language “A”) is not intended to designate or correlate to a specific spoken language. Rather, the intent is to identify that the designated language could be any language. The use of different capital letters indicates the use of different languages. For instance, when an example below indicates that the driver has designated a primary language “A” and a secondary language “B”, the intent is to indicate that the driver has designated a first language as the driver's primary language and the driver has further designated a second language, different from the first language, as the driver's secondary language.

As illustrated in FIG. 2, only one advisor, advisor 58′, speaks language “C”. According to an example, switch 52 routes the incoming call to an advisor (e.g., advisor 58′) who speaks the primary language of the driver.

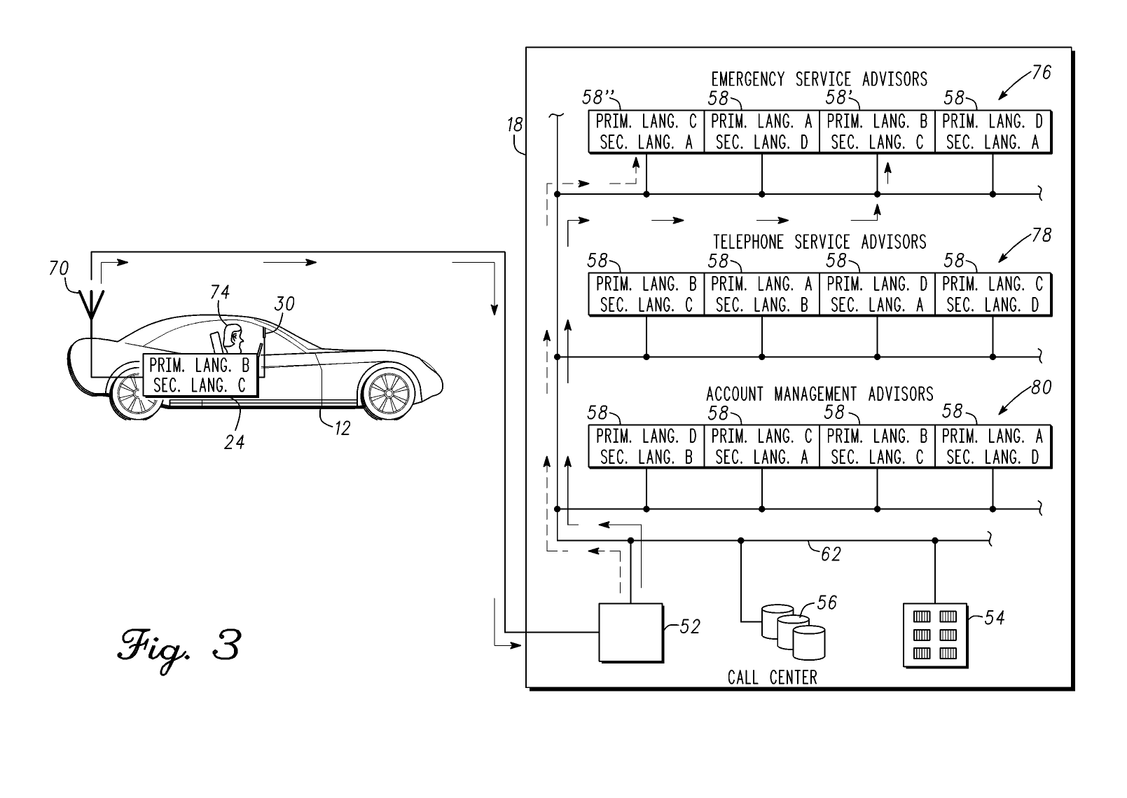

FIG. 3 schematically illustrates an exemplary system in which a method for routing calls in accordance with another example may be implemented. In FIG. 3, the advisors 58 are arranged in one of three queues that are relate to services provided by the call center. Accordingly, each queue may include advisors who are trained to provide one of several specific services provided by call center 18. The queues may be arranged electronically without regard to the advisor's actual location in call center 18. In the example illustrated in FIG. 3, queue 76 includes the identities of advisors who are trained in responding to emergency situations, queue 78 includes the identities of advisors who are trained in providing telephony services, and queue 80 includes the identities of advisors who are trained in providing account management services. Queues for these types of services are provided for example purposes only, and in other examples, queues for more, fewer or different types of services may be provided.

In FIG. 3, driver 74 has depressed one of the buttons and/or controls 30 associated with vehicle hardware 20 to request assistance. This action will cause telematics unit 28 to initiate contact with call center 18 by transmitting a wireless electronic signal over one or more communication networks, according to an example. As stated earlier, the wireless electronic signal may include information pertaining to the type of assistance that driver 74 may need. For example, the driver may require emergency services from call center 18, and this information is included in the wireless electronic signal. Additionally, in accordance with the example given herein, driver 74 has previously designated languages “B” and “C” as the primary and secondary languages, respectively, spoken by the driver. According to an example, the primary and secondary language designations also are conveyed to call center 18 in the wireless electronic signal.

When the wireless electronic signal is received by call center 18, switches 52 will determine, based on the signal, what type of assistance driver 74 requires and what languages are spoken by driver 74, and switches 52 will direct the call to an appropriate advisor 58 situated in the proper queue. These determinations are made by switches 52 using computer equipment and software integrated into and/or associated with switches 52, or through cooperation between switches 52, servers 54, and databases 56 which may communicate with one another across bus 62.

Protocols for determining which advisor 58 should receive the call for assistance may vary based on a variety of variables. As a general rule, the protocol may require that the next available appropriate advisor 58 in the queue receive the call. In a first example, an “appropriate” advisor may be an advisor whose primary language is the same as the primary language spoken by the driver. In the example illustrated in FIG. 3, the primary language spoken by the driver is language “B”. Accordingly, an appropriate advisor to receive the call for assistance is advisor 58′ because, as indicated, advisor 58′ speaks language “B” as his primary language. The routing of the call for assistance to advisor 58′ is illustrated with arrows drawn in solid lines.

In a second example, an appropriate advisor may be any advisor capable of speaking language “B”, regardless of whether it is the advisor's primary language, his secondary language, or so on. In that case, the appropriate advisor would be advisor 58″ because he is positioned ahead of advisor 58′ in the queue and because he is capable of speaking language “B”. The routing of the call for assistance to advisor 58″ is illustrated with arrows drawn in dotted lines.

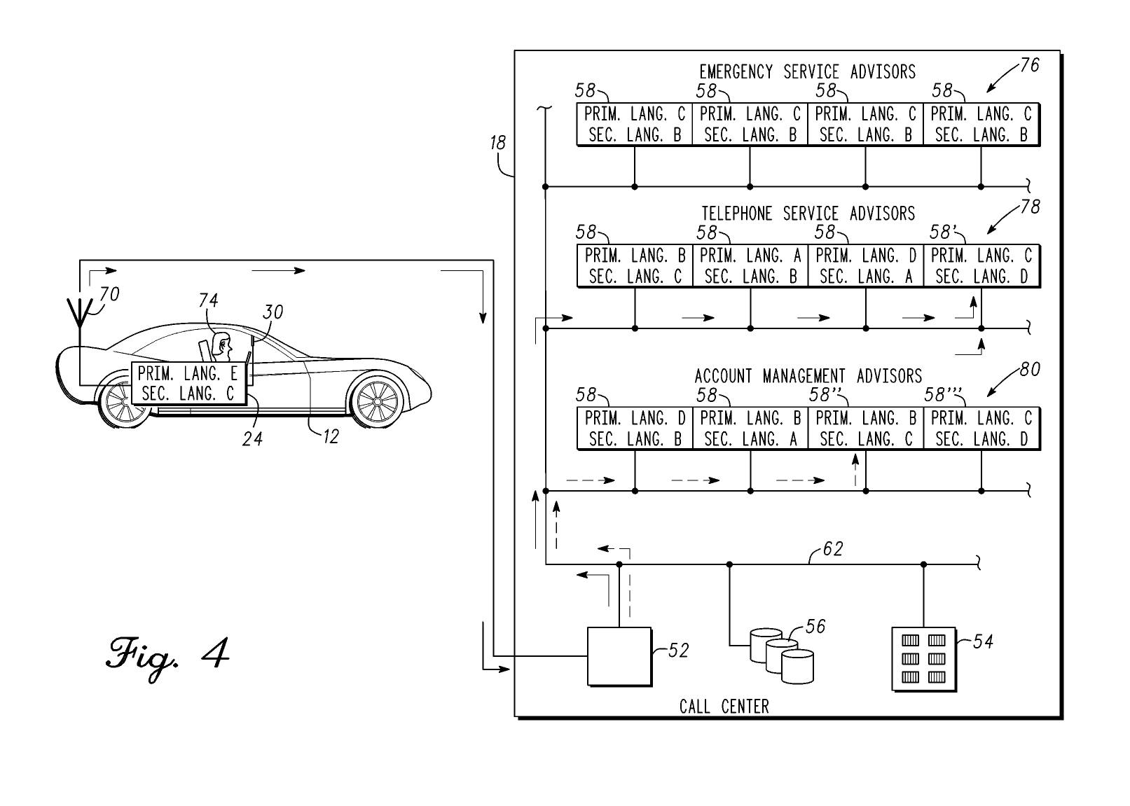

FIG. 4 schematically illustrates an exemplary system in which a method for routing calls in accordance with yet another example may be implemented. According to a different example from that given above, the driver 74 of FIG. 4 has previously designated language “E” as his primary language and language “C” as his secondary language. None of the available advisors in queues 76, 78, or 80 have designated to the system that they speak language “E” as either their primary or secondary languages, but there are several advisors who have designated to the system that they are able to speak language “C”.

In a first example, driver 74 seeks assistance from a telephony service advisor (e.g., by providing a user input indicating a request for telephony services). In this example, upon receipt of a wireless signal indicating the request and the languages spoken by the driver, the protocol used by call center 18 for selecting an appropriate advisor is to select the next available advisor in an appropriate queue (e.g., queue 78, which may be a queue associated with telephony services) whose primary language was previously designated to be any language spoken by driver 74. In this example, the call for assistance is not routed to advisors 58 in queue 78 (including those who speak language “C” as their secondary language) but is instead directed to advisor 58′ who is the first available advisor in the queue of telephony service advisors whose primary language is language “C”. This routing is illustrated in FIG. 4 with arrows drawn in solid lines.

In a second example, driver 74 seeks assistance from an account management advisor (e.g., by providing a user input indicating a request for account management services). In this example, upon receipt of a wireless signal indicating the request and the languages spoken by the driver, the protocol used by call center 18 for selecting an appropriate advisor is to select the next available advisor in the account management queue (i.e., queue 80) who previously designated to the system that they are capable of speaking any language spoken by driver 74, regardless of whether it is the advisor's primary or secondary language. Accordingly, the call for assistance is routed to advisor 58″ even though there is an advisor 58′″ whose primary language is language “C,” because advisor 58″ is the next advisor in line who can speak language “C”. The routing of this call for assistance is illustrated by arrows drawn in broken lines.

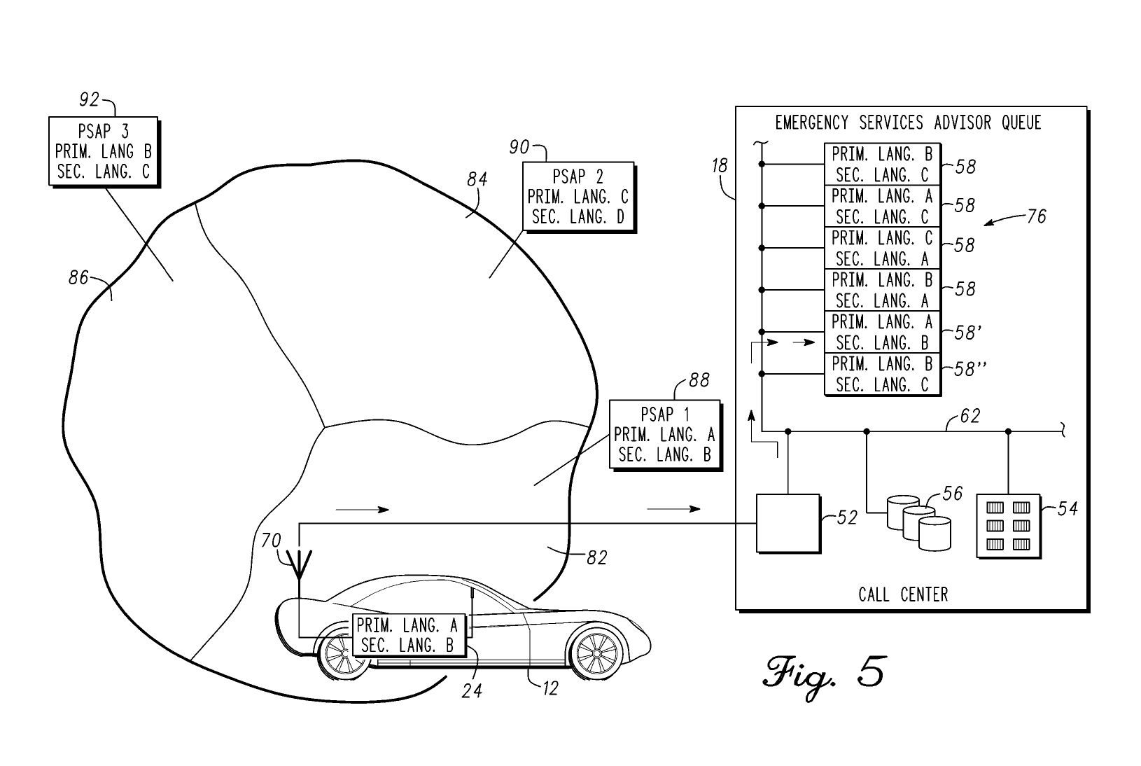

FIGS. 5-7 schematically illustrate several additional exemplary systems in which methods for routing calls in accordance with yet other examples may be implemented. In FIGS. 5-7, driver 74 seeks assistance from an emergency service advisor that will require the involvement of a PSAP that is configured to dispatch civil emergency service providers to assist the driver (e.g., by providing a user input indicating a request for emergency services). Additionally, in accordance with this example, driver 74 has previously designated language “A” as the primary language spoken by the driver.

In FIG. 5, vehicle 12 is located in first jurisdiction 82. The PSAP with responsibility for first jurisdiction 82 is first PSAP 88, which is capable of supporting two languages, a primary PSAP language “A” and a secondary PSAP language “B.” As used herein, the term “primary PSAP language” refers to a language that is native to the geographical region where the PSAP is located. As used herein, the term “secondary PSAP language” refers to any language other than the primary PSAP language that the PSAP has accepted responsibility for supporting.

When driver 74 requests assistance, telematics unit 24 transmits a wireless electronic signal through dual mode antenna 70 to call center 18 utilizing various communication networks. The wireless electronic signal includes information about the primary language spoken by the driver, the type of assistance the driver requires, and the position of vehicle 12 in latitude and longitude. In accordance with an example, the wireless electronic signal also may include information about one or more additional languages spoken by the driver.

When the signal is received, the call center electronically determines the primary language spoken by the driver. As above, this may be accomplished using computer equipment and software integrated into, or associated with, switches 52, or through cooperation between switches 52, servers 54, and databases 56 which may communicate with one another across bus 62. In addition, the call center determines which PSAP has jurisdiction for responding to vehicle 12 based on the latitude and longitude position conveyed with the wireless electronic signal and what languages are supported by that PSAP. For example, call center 18 may have files stored in databases 56 identifying the latitude and longitude positions of all PSAPs in a particular geographic region and may compare the latitude and longitude position of the vehicle 12 to determine which PSAP is closest to vehicle 12. In other examples, call center 18 may maintain map files in database(s) 56 that define the jurisdiction of each PSAP. Upon receipt of the wireless electronic signal, databases 56 may be accessed by other equipment at call center 18 to determine which PSAP has jurisdiction over vehicle 12. Databases 56 may also maintain files identifying the language spoken at, or otherwise supported by, each PSAP.

Call center 18 may determine the PSAP with jurisdiction over vehicle 12 and the language spoken at that PSAP using computer equipment and software integrated into, or associated with, switches 52, or through cooperation between switches 52, servers 54, and databases 56, which may communicate with one another across bus 62.

In the example illustrated in FIG. 5, having determined that the primary language spoken by driver 12 is language “A”, having determined that first PSAP 88 has responsibility for assisting driver 12, and having determined that first PSAP 88 supports language “A”, call center 18 next identifies an appropriate advisor for responding to the request for assistance. In this example, the request for assistance is routed to advisor 58′ whose primary language is also language “A” and who is nearest the front of queue 76 (e.g., a queue associated with emergency services).

This example illustrates the use of a protocol that prioritizes matching drivers and PSAPs with advisors having common primary languages. In other examples, the protocol may simply look for any languages in common and may match the next available advisor capable of speaking any of the languages spoken by both the driver and the PSAP. Utilizing such a protocol in FIG. 5 would result in routing the call for assistance to advisor 58″ who speaks language “B”, a language that is also spoken by driver 12 and that is supported by first PSAP 88.

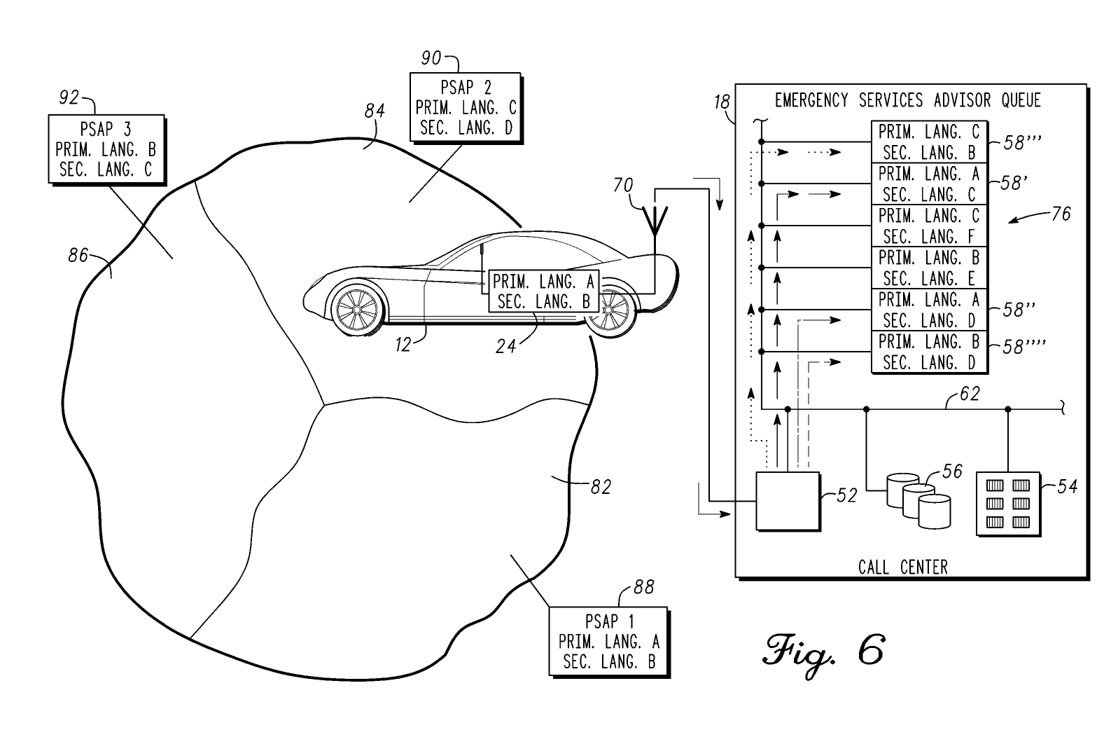

In conjunction with FIG. 6, multiple examples are described below for different protocols for routing a call for assistance under circumstances where the driver does not speak a common language with the responsible PSAP. As indicated, vehicle 12 requests assistance from within a second jurisdiction 84. The languages designated by driver 12 are primary language “A” and secondary language “B”. The PSAP with responsibility over second jurisdiction 84 is second PSAP 90. The languages supported by second PSAP 90 are primary language “C” and secondary language “D”.

According to an example, the call center utilizes a first protocol that places priority on matching a driver with the first available advisor who speaks the primary languages spoken by both the drivers and PSAPs. Accordingly, call center 18 routes the call for assistance to advisor 58′ who speaks both language “A” and language “C”. The routing of this call for assistance is illustrated with arrows drawn in solid lines.

According to another example, the call center utilizes a second protocol, which places a priority on matching a driver with the first available advisor who speaks the driver's primary language and who speaks any language supported by the PSAP. Accordingly, the call for assistance is routed to advisor 58″ who speaks language “A” (the driver's primary language) and language “D” (the secondary language supported by the PSAP). The routing of this call for assistance is illustrated with arrows drawn in broken lines.

According to yet another example, the call center utilizes a third protocol, which places a priority on matching a driver with the first available advisor who speaks the PSAP's primary language and any language spoken by the driver. Accordingly, the call for assistance is routed to advisor 58′″ who speaks language “C” (the primary language spoken by second PSAP 90) and language “B” (one of the languages spoken by driver 12). This example assumes that advisor 58′ is unavailable. The routing of this call for assistance is illustrated with arrows drawn in dotted lines.

According to yet another example, the call center utilizes a fourth protocol, which places a priority on matching a driver with the first available advisor who speaks any language supported by the PSAP and any language spoken by the driver. Accordingly, the call for assistance is routed to advisor 58′″ who speaks language “B” and language “D”, the secondary language of driver 12 and second PSAP 90, respectively. The routing of this call for assistance is illustrated with arrows drawn in dashed lines.

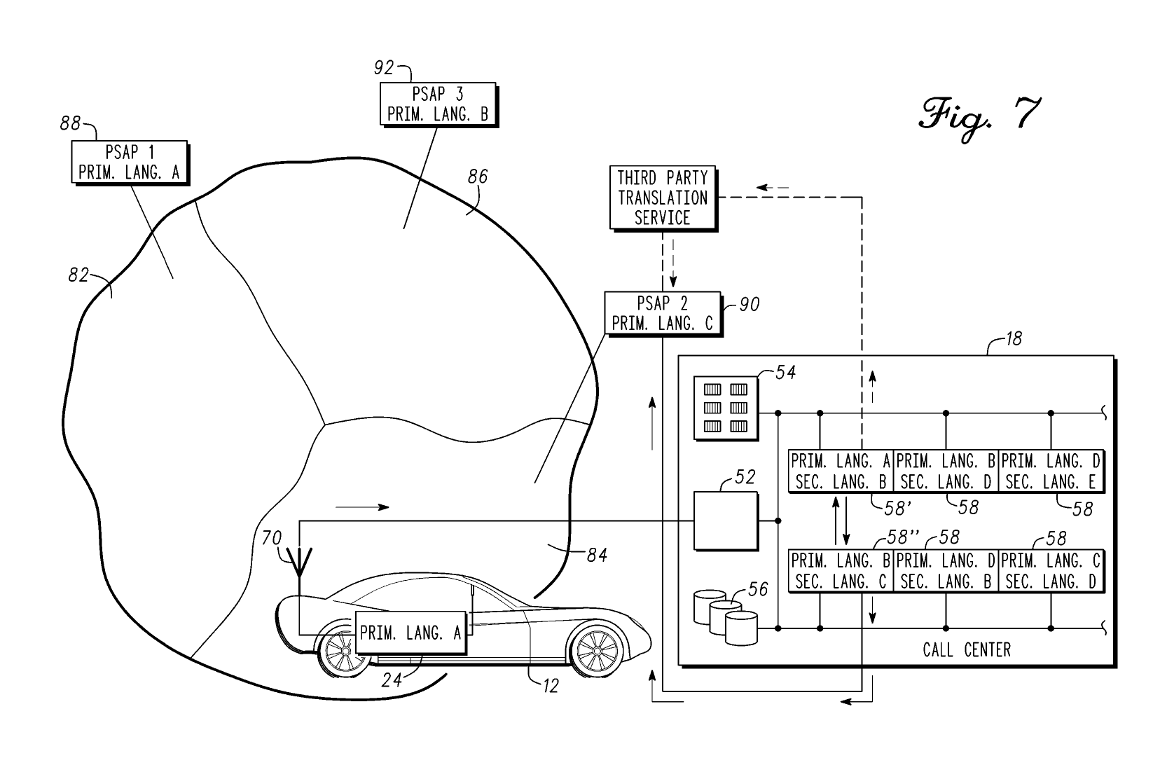

In conjunction with FIG. 7, two additional examples are described below for different protocols for routing a call for assistance. In these two examples, the call center determines that no advisors are available who are able to speak both a language spoken by the driver and a language supported by the PSAP with jurisdiction over the driver.

In the first example, vehicle 12 requests assistance while situated in second jurisdiction 84. The driver of vehicle 12 has designated language “A” as his primary language with no secondary languages designated. Second PSAP 90 supports only language “C”. Additionally, none of the available advisors 58 at call center 18 can speak both languages “A” and “C”. Under these circumstances, when a request for assistance is received at call center 18, a protocol may be implemented which matches driver 12 with more than one advisor. For example, driver 12 may be matched with a first advisor 58′ who speaks both language “A” and one additional language, language “B”, according to an example. Driver 12 may also be matched with a second advisor 58″who speaks language “C” and the one additional language spoken by the first advisor, language “B”. In this manner, communication may flow back and forth between driver 12 and second PSAP 90 through the first and second advisors 58′, 58″ who can speak to each other in language “B”. The routing of this call for assistance is illustrated with arrows drawn in solid lines.

In a second example, vehicle 12 again may request assistance while situated in second jurisdiction 84. The driver of vehicle 12 has designated language “A” as his primary language with no secondary languages designated. Second PSAP 90 supports only language “C”. Additionally, the call center has determined that none of the available advisors 58 at call center 18 can speak both languages “A” and “C”. Furthermore, in this example, advisor 58″ is not available to assist advisor 58′. Under these circumstances, advisor 58′, upon receiving the call for assistance, will contact a third party translation service such as, but not limited to, the AT&T Language Line, to obtain translation services. The routing of this call for assistance is illustrated with arrows drawn with dotted lines.

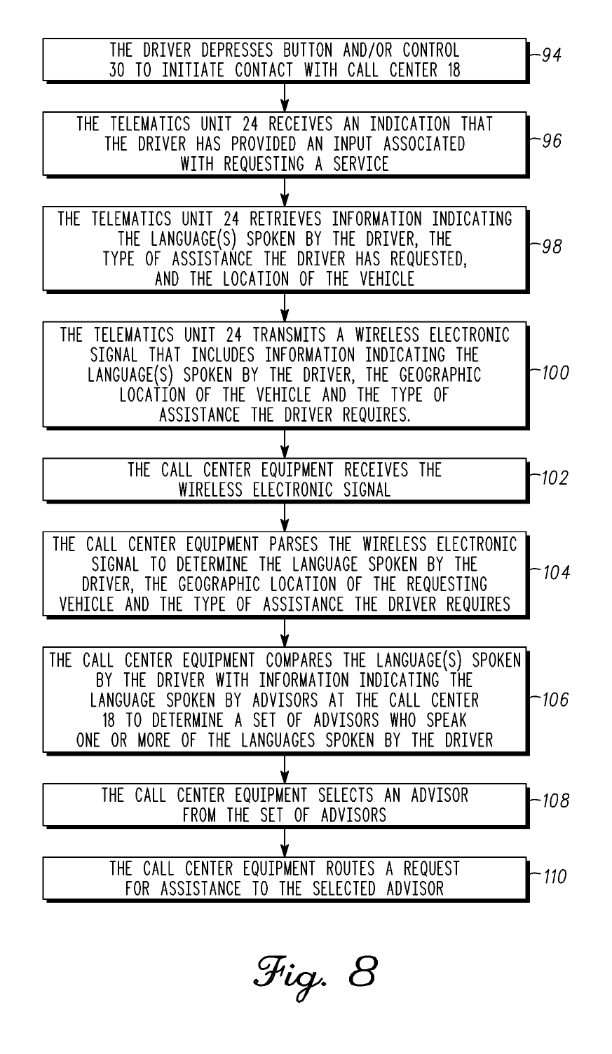

FIG. 8 illustrates a flow chart depicting a non-limiting example of the steps taken by driver 74, telematics unit 24 and call center 18 during a typical request for assistance. At step 94, driver 74 initiates contact with call center 18 by depressing buttons and/or controls 30. In an example, the precise button or control depressed by driver 74 may correlate with the type of assistance the driver requires. The button push sends an electronic signal from buttons and/or controls 30 to telematics unit 24.

At step 96, telematics unit 24 receives the electronic signal from buttons and/or controls 30. The receipt of this electronic signal at telematics unit 24 provides telematics unit 24 with an indication that the driver has requested a service from call center 18.

At step 98, in preparation for transmitting a wireless electronic signal to call center 18, electronic processing device 38 accesses electronic memory 40 to retrieve information indicative of the language(s) spoken by driver 74, in an example. At the same time, electronic processing device 38 may also retrieve information indicative of the location of vehicle 12 from GPS chipset/component 42.

At step 100, telematics unit 24 transmits a wireless electronic signal to call center 18 through dual mode antenna 70. In an example, the wireless electronic signal includes information indicating the language(s) spoken by driver 74 and the geographical location of vehicle 12 as well as an indication of the type of assistance requested by driver 74 (gleaned from the specific button and/or control 30 depressed by driver 74).

At step 102, the wireless electronic signal is received at call center 18 by the call center equipment. At step 104, in an example, the call center equipment parses the wireless electronic signal to determine the language(s) spoken by the driver. In an example, the call center equipment also parses the signal to determine the geographical location of the vehicle requesting assistance and also the type of assistance required by driver 74.

At step 106, the call center equipment compares the language(s) spoken by driver 74 with information that is stored at call center 18 or that is otherwise accessible to the call center equipment and that is indicative of the languages spoken by advisors on duty at call center 18. In an example, this comparison permits the call center equipment to determine a set of advisors who speak one or more of the languages spoken by the driver.

At step 108, the call center selects an advisor from the set of advisors selected in step 106 and at step 110, the call center equipment routes a request for assistance to the selected advisor using one or more of the protocols previously discussed.

While at least one example method has been presented in the foregoing detailed description, it should be appreciated that a vast number of variations exist. It should also be appreciated that the exemplary example (s) are not intended to limit the scope, applicability, or configuration in any way. Rather, the foregoing detailed description will provide those skilled in the art with a convenient road map for implementing the exemplary example (s). It should be understood that various changes can be made in the function and arrangement of elements without departing from the scope as set forth in the appended claims and the legal equivalents thereof.

What is claimed is:

1. A method for routing calls at a call center based on spoken languages, the method comprising:
receiving, by a call center, an electronic signal containing a request for assistance from a driver of a vehicle, the electronic signal further containing an identification of one or more languages spoken by the driver;
automatically identifying, by the call center, an available advisor who speaks at least one of the one or more languages; and
directing the request for assistance to the available advisor.

2. The method of claim 1 further comprising the step of arranging a plurality of advisors in a queue, and wherein the step of identifying an available advisor comprises identifying the available advisor as an advisor who speaks at least one of the one or more languages spoken by the driver and who is positioned closest to a front of the queue.

3. The method of claim 1 further comprising the step of arranging a plurality of advisors in a plurality of queues, each queue relating to differing types of assistance provided by the call center, and wherein the step of identifying an available advisor comprises identifying the available advisor who is positioned closest to a front of a queue of the plurality of queues that corresponds to the request.

4. The method of claim 1, wherein the information identifying the one or more languages includes information identifying a primary language spoken by the driver and a secondary language spoken by the driver, the method further comprising identifying an available advisor who speaks the secondary language spoken by the driver and wherein the step of directing the request comprises directing the request to the available advisor who speaks the secondary language spoken by the driver.

5. The method of claim 1 wherein the step of identifying an available advisor comprises identifying an available advisor as an advisor who speaks a plurality of languages, one of which is a language spoken by the driver, and wherein the step of directing the request comprises directing the request to the available advisor who speaks the plurality of languages.

6. The method of claim 1, wherein the information identifying the one or more languages includes information identifying a primary language spoken by the driver, and wherein the step of identifying an available advisor comprises identifying an available advisor as an advisor who speaks a primary advisor language and a secondary advisor language, wherein the secondary advisor language is the primary language spoken by the driver, and wherein the step of directing the request comprises directing the request to the available advisor who speaks the primary advisor language and the secondary advisor language.

7. The method of claim 1, wherein the information identifying the one or more languages includes information identifying a primary language spoken by the driver and a secondary language spoken by the driver, wherein the step of identifying an available advisor comprises identifying the available advisor as an advisor who speaks a primary advisor language and a secondary advisor language, wherein the secondary advisor language is the secondary language spoken by the driver, and wherein the step of directing the request comprises directing the request to the available advisor.

8. A method for routing calls at a call center based on spoken languages, the method comprising:
receiving, by a call center, information indicating a request for assistance from a driver of a vehicle and information indicating one or more languages spoken by the driver;
automatically identifying, by the call center, a PSAP with responsibility for providing emergency services to the driver;
automatically determining, by the call center, one or more languages spoken at the PSAP;
automatically identifying, by the call center, an available advisor who speaks at least one of the one or more languages spoken by the driver and at least one of the one or more languages spoken at the PSAP; and
automatically directing the request to the available advisor.

9. The method of claim 8 wherein the one or more languages spoken by the driver differ from the one or more languages spoken at the PSAP, wherein the step of automatically identifying an available advisor comprises identifying an available advisor who speaks a plurality of languages, one of which is one of the one or more languages spoken by the driver and another one of which is one of the one or more languages spoken by the PSAP.

10. The method of claim 8, wherein the information identifying the one or more languages spoken by the driver includes information identifying a primary language spoken by the driver and a secondary language spoken by the driver, the method further comprising:
automatically identifying an available advisor who speaks the secondary language spoken by the driver,
wherein the step of automatically directing the request comprises directing the request to the available advisor who speaks the secondary language spoken by the driver.

11. The method of claim 8, wherein the step of automatically determining one or more languages spoken at the PSAP includes automatically determining a primary PSAP language and a secondary PSAP language, the method further comprising:
automatically identifying an available advisor who speaks the secondary PSAP language,
wherein the step of automatically directing the request comprises automatically directing the request to the available advisor who speaks the secondary PSAP language.

12. The method of claim 8 wherein the information identifying the one or more languages spoken by the driver includes information identifying a primary language spoken by the driver and a secondary language spoken by the driver, and wherein the step of automatically determining one or more languages spoken at the PSAP includes determining a primary PSAP language and a secondary PSAP language, the method further comprising:
automatically identifying an available advisor who speaks the secondary language spoken by the driver and who speaks the secondary PSAP language,
wherein the step of automatically directing the request comprises automatically directing the request to the available advisor who speaks the secondary language spoken by the driver and who speaks the secondary PSAP language.

13. The method of claim 8 further comprising the step of automatically determining a location of the vehicle, and wherein the step of automatically identifying a PSAP comprises automatically identifying a PSAP with responsibility for providing emergency services in a geographic area where the vehicle is located.

14. The method of claim 13 wherein the step of automatically determining a location of the vehicle comprises obtaining a latitude and a longitude position of the vehicle from the request for assistance.

15. The method of claim 8 further comprising the step of arranging a plurality of advisors in a queue and wherein the step of identifying an available advisor comprises identifying the available advisor as an advisor who speaks at least one of the one or more languages spoken by the driver and who speaks at least one of the one or more languages spoken at the PSAP who is positioned closest to a front of the queue.

16. The method of claim 8 further comprising the step of arranging a plurality of advisors in a plurality of queues, each queue relating to differing types of assistance provided by the call center, and wherein the step of identifying an available advisor comprises identifying an advisor who is positioned closest to a front of a queue of the plurality of queues that corresponds to the request.

17. The method of claim 8 wherein the step of automatically determining the one or more languages spoken at the PSAP comprises electronically accessing information stored in a computer storage component.

18. The method of claim 8 wherein the step of automatically determining the one or more languages spoken by the driver comprises electronically parsing the request for assistance.

19. A system for routing calls based on spoken languages, the system comprising:
a call center housing communication equipment and computer equipment communicatively connected to one another; and
a plurality of advisors located within the call center,
wherein the communication equipment is configured to receive an electronic signal from a vehicle, the electronic signal containing information identifying a language spoken by a driver of the vehicle, and to automatically communicate the electronic signal to the computer equipment, and wherein the computer equipment is configured to automatically determine from the electronic signal the language spoken by the driver of the vehicle, to automatically identify an advisor of the plurality of advisors who speaks the language spoken by the driver of the vehicle, and to automatically route the request for assistance to the advisor.

20. The system of claim 19 further comprising a telematics unit mounted in the vehicle, the telematics unit being configured to electronically store the language spoken by the driver and to transmit the electronic signal to the call center.
